(19) United States
(12) Patent Application Publication
(10) Pub. No.: US 2009/0194091 A1
(43) Pub. Date: Aug. 6, 2009

(54) Barbecue grill

(76) Inventor: Ming Dong, Nanhui District (CN)

Correspondence Address: COOPER & DUNHAM, LLP, 30 Rockefeller Plaza, 20th Floor, NEW YORK, NY, 10112, US

(21) Appl. No.: 12/012,736

(22) Filed: Feb. 5, 2008

(51) Int. Cl. A47J 37/07

(52) U.S. Cl. 126/25 R

(57) ABSTRACT

A barbecue grill has a body and a cover. The body has an open top, an inner chamber and a net. The net is mounted on the top. The cover covers the open top of the body and has an outer surface, an inner surface, a handle, at least one vent and a rotatable seal. The handle is mounted on the outer surface of the cover. The vent is defined through the cover and communicates with the inner chamber of the body. The rotatable seal is mounted rotatably on the inner surface of the cover and has at least one tab. The tab corresponds to the vent and is rotatably turned to selectively close and open the vent to release smoke and heat through the vent without removing the cover smoke and heat are easily released controllable.

### BACKGROUND OF THE INVENTION

1. Field of Invention

The present invention relates to a barbecue grill, and more particularly to a barbecue grill allowing easy control of smoke and heat to improve cooking.

2. Description of the Related Art

A traditional barbecue grill only has a body. The body stands on a flat surface such as a patio, ground or the like and has an open top, an inner chamber and a net. The inner chamber holds charcoal and other combustibles that generate smoke when burned. The net is mounted over the open top and allows food to be mounted on the net and allow food to be cooked.

However, if food is cooked without a cover, smoke cannot stay in the inner chamber for added flavor.

With reference to FIG. 6, a conventional barbecue grill has a body (30) and a cover (31). The body (30) stands on a flat surface such as a patio, ground or the like and has an open top, an inner chamber and a net. The inner chamber holds charcoal and other combustibles that generate smoke when burned. The net is mounted over the open top and allows food to be mounted on the net and allow food to be cooked. The cover (31) selectively covers the open top of the body (30) to cover food inside the barbecue grill, make cooking easier and more consistent and prevent wind blowing ash over the food and people. The cover (31) has an outer surface and a handle (32). The handle (32) may be a thermal insulator and is mounted on the outer surface of the cover (31) for safe handling of the cover (31):

Some people like to eat food with rich flavor while some people like to eat food with light flavor. Therefore, an amount of smoke is preferably controlled to taste by periodically detaching the cover (31) from the body (30). However, when the cover (31) of the conventional barbecue grill is removed, much smoke is uncontrollably released along with heat. Accordingly, the amount of smoke in the conventional barbecue grill is not easily controlled and neither is the heat.

To overcome the shortcomings, the present invention provides a barbecue grill to mitigate or obviate the aforementioned.

### SUMMARY OF THE INVENTION

The primary objective of the present invention is to provide a barbecue grill allowing easy control of smoke and heat to improve cooking.

To achieve the objective, the barbecue grill in accordance with the present invention has a body and a cover. The body has an open top, an inner chamber and a net. The net is mounted on the top. The cover covers the open top of the body and has an outer surface, an inner surface, a handle, at least one vent and a rotatable seal. The handle is mounted on the outer surface of the cover. The vent is defined through the cover and communicates with the inner chamber of the body. The rotatable seal is mounted rotatably on the inner surface of the cover and has at least one tab. The tab corresponds to the vent and is rotatably turned to selectively close and open the vent to release smoke and heat through the vent without removing the cover so smoke and heat are easily released controllable.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a barbecue grill in accordance with the present invention;

FIG. 2 is an exploded perspective view of the barbecue grill in FIG. 1;

FIG. 3 is an enlarged perspective view of a smoke adjuster of the barbecue grill in FIG. 1;

FIG. 4 is a cross sectional side view of the smoke adjuster of the barbecue grill in FIG. 3;

FIG. 5 is a perspective view of the barbecue grill in FIG. 1 with multiple hooks and a table; and

FIG. 6 is a perspective view of a conventional barbecue grill in accordance with the prior art.

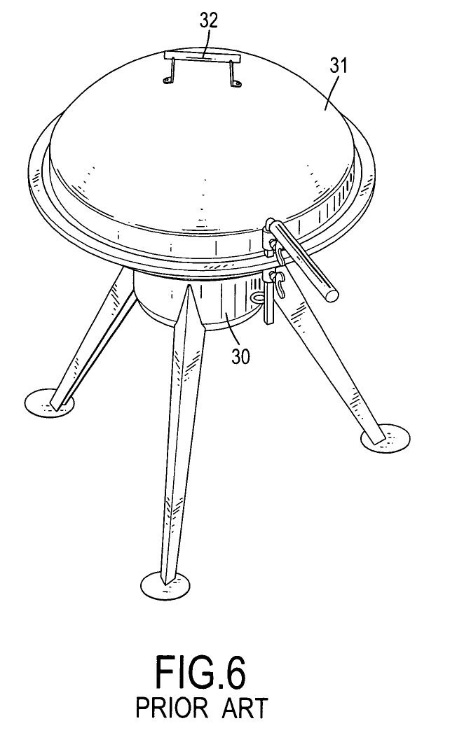

### DETAILED DESCRIPTION OF THE INVENTION

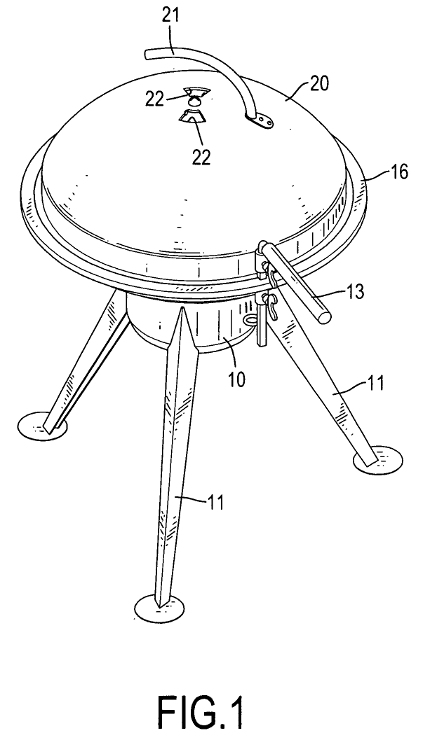

With reference to FIG. 1, a barbecue grill in accordance with the present invention has a body (10) and a cover (20).

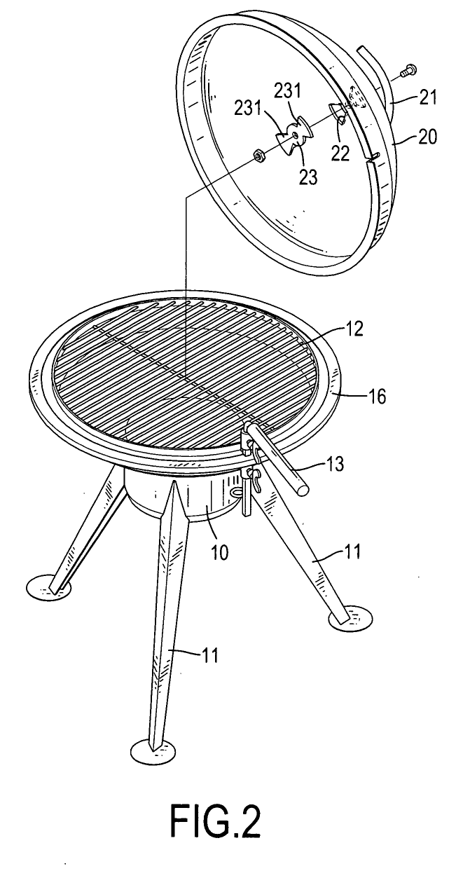

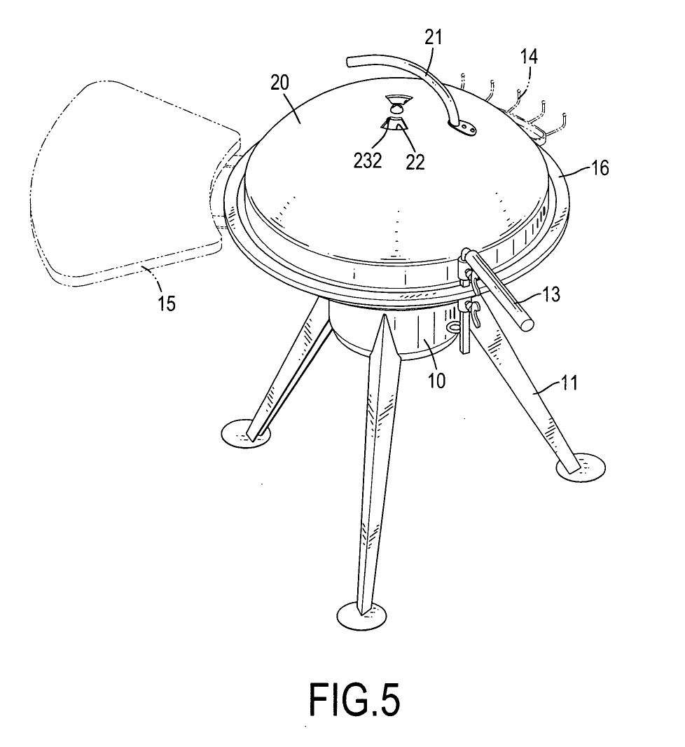

With further reference to FIGS. 2 and 5, the body (10) has an open top, an inner chamber, a net (12), a bracket, multiple optional hooks (14) and an optional table (15). The open top has an outer edge (16). The inner chamber holds combustibles including charcoal, briquettes, coal, wood and/or the like that generate heat and smoke when burned. The net (12) is removably mounted over the open top and allows food to be mounted thereon while being removable to add more combustibles, thereby allowing food to be cooked. The net (12) has a net holder (13). The net holder (13) may be a thermal insulator, is connected to the net (12) and allows holding and removal of the net (12). The bracket is mounted on the body (10), holds the barbecue grill and allows the barbecue grill to be mounted steadily on a surface such as a patio, deck, ground or the like. The bracket may have three legs (11) to support the barbecue grill. The hooks (14) protrude from the outer edge (16) to allow food or cooking implements to be hung from the barbeque. The table (15) is attached to and protrudes from the outer edge (16) to hold food, plates or implements or the like.

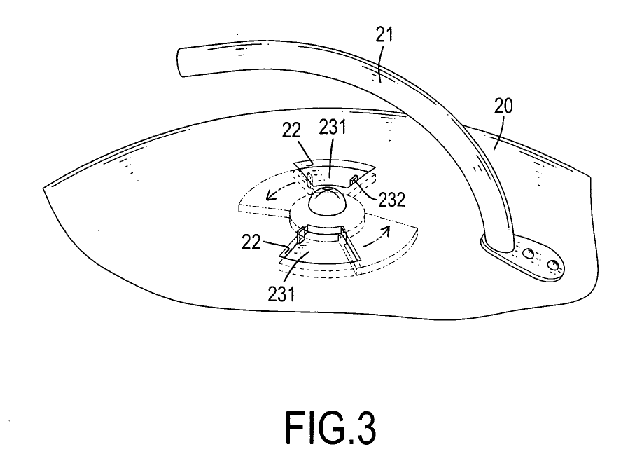

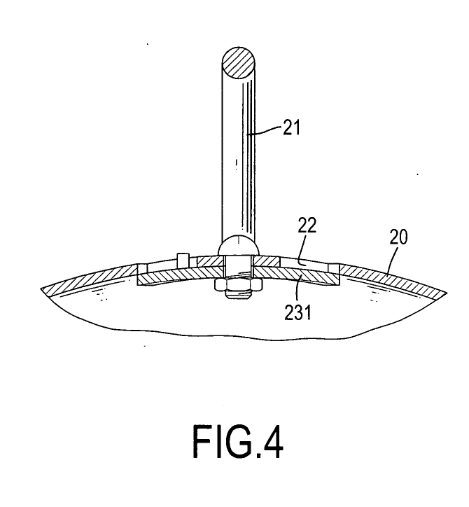

With further reference to FIGS. 3 and 4, the cover (20) removably covers the open top of the body (10) to cover food inside the barbecue grill, trap heat and smoke inside for adding to flavor and raising temperature therein. The cover (20) has an outer surface, an inner surface, a handle (21), at least one vent (22) and a rotatable seal (23). The handle (21) is mounted on the outer surface of the cover (20) and may be a thermal insulator to allow safe handling of the cover (20). The at least one vent (22) is defined through the cover (20) and communicates with the inner chamber of the body (10) to allow smoke and heat to be controllably released therethrough the vent (22). The seal (23) is mounted rotatably on the inner surface of the cover (20), selectively seals the at least one vent (22) and has at least one tab (231) corresponding respectively to the at least one vent (22). Each tab (231) vent has two sides and a protrusion (232). The protrusion (232) is formed on and protrudes from one side of the tab (231) and is mounted movably in a corresponding vent (22) and prevents over-rotation of the seal (23) and allows the seal (23) to be rotated to selectively to close or open the vent (22).

Preferably the cover (20) has two vents (22) vent arranged diametrically and the seal (23) has two tabs (231) respectively corresponding to and covering the vents (22).

The seal (23) can be controllably rotated to selectively release smoke and heat from the vent (22) to reduce smoke and heat inside without opening the barbecue grill. The users can therefore control how the food cooks to improve barbecuing experience while being simple to use.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A barbecue grill comprising:
a body having
an open top;
an inner chamber; and
a net being removably mounted over the top;
a cover removably covering the open top of the body and having
an outer surface;
an inner surface;
a handle being mounted on the outer surface of the cover;
at least one vent being defined through the cover and communicating with the inner chamber of the body; and
a rotatable seal being mounted rotatably on the inner surface of the cover, selectively sealing the at least one vent and having
at least one tab corresponding respectively to the at least one vent and each tab having
two sides; and
a protrusion protruding from one of the end of the tab and being mounted movably in a corresponding vent to prevent over-rotation.

2. The barbecue grill as claimed in claim 1, wherein
the cover has two vents being arranged diametrically; and
the seal has two tabs respectively corresponding to and covering the vents.

3. The barbecue grill as claimed in claim 1, wherein the net further has a net holder being connected to the net.

4. The barbecue grill as claimed in claim 2, wherein the net further has a net holder being connected to the net.

5. The barbecue grill as claimed in claim 3, wherein body further has a bracket being mounted on the body and the bracket holding the barbecue grill.

6. The barbecue grill as claimed in claim 5, wherein the bracket further has three legs to support the barbecue grill.

7. The barbecue grill as claimed in claim 4, wherein body further has a bracket being mounted on the body and the bracket holding the barbecue grill.

8. The barbecue grill as claimed in claim 7, wherein the bracket further has three legs to support the barbecue grill.

9. The barbecue grill as claimed in claim 1, wherein
the open top of the body has an outer edge; and
the body further has
multiple hooks protruding from the outer edge of the top of the body; and
a table being attached to and protruding from the outer edge of the top of the body.

10. The barbecue grill as claimed in claim 2, wherein
the open top of the body has an outer edge; and
the body further has
multiple hooks protruding from the outer edge of the top of the body; and
a table being attached to and protruding from the outer edge of the top of the body.

11. The barbecue grill as claimed in claim 3, wherein
the open top of the body has an outer edge; and
the body further has
multiple hooks protruding from the outer edge of the top of the body; and
a table being attached to and protruding from the outer edge of the top of the body.

12. The barbecue grill as claimed in claim 4, wherein
the open top of the body has an outer edge; and
the body further has
multiple hooks protruding from the outer edge of the top of the body; and
a table being attached to and protruding from the outer edge of the top of the body.

13. The barbecue grill as claimed in claim 5, wherein
the open top of the body has an outer edge; and
the body further has
multiple hooks protruding from the outer edge of the top of the body; and
a table being attached to and protruding from the outer edge of the top of the body.

14. The barbecue grill as claimed in claim 6, wherein
the open top of the body has an outer edge; and
the body further has
multiple hooks protruding from the outer edge of the top of the body; and
a table being attached to and protruding from the outer edge of the top of the body.

15. The barbecue grill as claimed in claim 7, wherein
the open top of the body has an outer edge; and
the body further has
multiple hooks protruding from the outer edge of the top of the body; and
a table being attached to and protruding from the outer edge of the top of the body.

16. The barbecue grill as claimed in claim 8, wherein
the open top of the body has an outer edge; and
the body further has
multiple hooks protruding from the outer edge of the top of the body; and
a table being attached to and protruding from the outer edge of the top of the body.
